(19) United States
(12) Patent Application Publication
(10) Pub. No.: US 2017/0324567 A1
(43) Pub. Date: Nov. 9, 2017

(54) SIGNATURE VERIFICATION DEVICE, SIGNATURE GENERATION DEVICE, SIGNATURE PROCESSING SYSTEM, SIGNATURE VERIFICATION METHOD, AND SIGNATURE GENERATION METHOD

(71) Applicant: PANASONIC INTELLECTUAL PROPERTY MANAGEMENT CO., LTD., Osaka (JP)

(72) Inventor: Masakatsu MATSUO, Fukuoka (JP)

(73) Assignee: PANASONIC INTELLECTUAL PROPERTY MANAGEMENT CO., LT D., Osaka (JP)

(21) Appl. No.: 15/528,908

(22) PCT Filed: Dec. 4, 2015
(86) PCT No.: PCT/JP2015/006022

§ 371 Date: May 23, 2017

(30) Foreign Application Priority Data
Dec. 16, 2014 (JP) 2014-254570

(51) Int. Cl. H04L 9/32; H04L 9/30; H04L 9/08; H04L 29/06

(52) U.S. Cl. CPC H04L 9/3268; H04L 63/0428; H04L 9/3247; H04L 9/0861; H04L 9/30; H04L 9/0894; H04L 9/3236

(57) ABSTRACT

A signature verification device includes a communicator that receives a second server certificate including a second public key and receives signature data which is generated by encrypting a hash value derived from the second server certificate using a secret key forming a key pair with the first public key, a signature processor that decrypts the signature data by using the first public key stored in the storage to acquire a first hash value, a unidirectional function deriver that derives a second hash value from the second server certificate, and a signature verifier that determines a signature generation device generating the signature data to be correct in a case of the first hash value and the second hash value matching. Decrease of accuracy of signature verification is reduced with reduced cost and secured security.

### TECHNICAL FIELD

The present disclosure relates to a signature verification device, a signature generation device, a signature processing system, a signature verification method, and a signature generation method.

### BACKGROUND ART

In the case of a server apparatus sending a server certificate (includes a public key) to a terminal, a digital signature (signature data) that is issued by a certificate authority (CA) is attached to the server certificate in order to ensure that the server certificate is valid.

The terminal, if receiving the server certificate to which the signature data of the certificate authority is attached, decrypts the signature data with the public key of the certificate authority and calculates a hash value H of the signature data.

As this type of preceding technology, a technology related to digital signature is disclosed in NPL 1.

An object of the present disclosure is to reduce decrease of the accuracy of signature verification with reduced cost and secured security.

### CITATION LIST

### Non-Patent Literature

NPL 1: Sosuke Matsui, Miho Shimano, Takahiro Okabe, and Yoichi Sato, “Image Enhancement of Low-Light Scenes with Near-Infrared Flash Images,” in Proc. Asian Conference on Computer Vision (ACCV2009), p. 213-223, September 2009

### SUMMARY OF THE INVENTION

A signature verification device of the present disclosure includes a storage that stores a first server certificate including a first public key, a communicator that receives a second server certificate including a second public key and receives signature data which is generated by encrypting a hash value derived from the second server certificate using a secret key forming a key pair with the first public key, a signature processor that decrypts the signature data by using the first public key to acquire a first hash value, a unidirectional function deriver that derives a second hash value from the second server certificate, and a signature verifier that determines a signature generation device generating the signature data to be correct in a case of the first hash value and the second hash value matching.

A signature generation device of the present disclosure includes a key generator that generates a key pair of a first public key and a first secret key and a key pair of a second public key and a second secret key, a certificate generator that generates a first server certificate including the first public key and updates the first server certificate to generate a second server certificate including the second public key, a unidirectional function deriver that derives a hash value from the second server certificate, and a signature generator that encrypts the hash value by using the first secret key to generate signature data.

A signature processing system of the present disclosure is a signature processing system in which a signature generation device and a signature verification device are connected to each other through a network, in which the signature generation device includes a key generator that generates a key pair of a first public key and a first secret key and a key pair of a second public key and a second secret key, a certificate generator that generates a first server certificate including the first public key and updates the first server certificate to generate a second server certificate including the second public key, a unidirectional function deriver that derives a hash value from the second server certificate, a signature generator that encrypts the hash value by using the first secret key to generate signature data, and a first communicator that sends the second server certificate and the signature data, and the signature verification device includes a storage that stores the first server certificate including the first public key, a second communicator that receives the second server certificate and the signature data, a signature processor that decrypts the signature data by using the first public key to acquire a first hash value, a unidirectional function deriver that derives a second hash value from the second server certificate, and a signature verifier that determines the signature generation device to be correct in a case of the first hash value and the second hash value matching.

A signature verification method of the present disclosure is a signature verification method in a signature verification device including a storage that stores a first server certificate including a first public key, the method including a step of receiving a second server certificate including a second public key and receiving signature data which is generated by encrypting a hash value derived from the second server certificate using a secret key forming a key pair with the first public key, a step of decrypting the signature data by using the first public key to acquire a first hash value, a step of deriving a second hash value from the second server certificate, and a step of determining a signature generation device generating the signature data to be correct in a case of the first hash value and the second hash value matching.

A signature generation method of the present disclosure is a signature generation method by which a signature generation device generates signature data, the method including a step of generating a key pair of a first public key and a first secret key, a step of generating a first server certificate including the first public key, a step of generating a key pair of a second public key and a second secret key, a step of updating the first server certificate to generate a second server certificate including the second public key, a step of deriving a hash value from the second server certificate, and a step of encrypting the hash value by using the first secret key to generate signature data.

According to the present disclosure, decrease of accuracy of signature verification can be reduced with reduced cost for acquisition of digital signature and with secured security.

### BRIEF DESCRIPTION OF DRAWINGS

FIG. 1 is a block diagram illustrating a configuration example of a signature processing system in an exemplary embodiment.

FIG. 2 is a block diagram illustrating a configuration example of a server apparatus in the exemplary embodiment.

FIG. 3 is a block diagram illustrating a configuration example of a terminal in the exemplary embodiment.

FIG. 4 is a schematic diagram for describing updating of a server certificate and signature data by the server apparatus in the exemplary embodiment.

FIG. 5 is a timing chart illustrating one example of an update operation for the server certificate by the signature processing system in the exemplary embodiment.

FIG. 6A is a flowchart illustrating one example of a generation operation procedure for the server certificate and the signature data by the server apparatus in the exemplary embodiment.

FIG. 6B is a flowchart illustrating one example of a communication operation procedure by the server apparatus in the exemplary embodiment.

FIG. 7 is a flowchart illustrating one example of a signature verification operation procedure by the terminal in the exemplary embodiment.

### DESCRIPTION OF EMBODIMENT

Hereinafter, an exemplary embodiment of the present disclosure will be described by using the drawings.

In digital signature, when a server apparatus sends a server certificate (includes a public key) to a terminal, a certificate authority which is a third party has to intervene. Thus, expense is incurred for the digital signature by the certificate authority.

The certificate authority assumes the server apparatus, as a requester requesting the server certificate, to be a correct server apparatus and, in a state of correctness of the requester not being sufficiently examined, issues the server certificate to which signature data made by the certificate authority is added. In this case, a terminal may acquire the server certificate including the public key from the server apparatus as an incorrect requester. That is, spoofing that makes an incorrect server apparatus to be a correct server apparatus can be performed, and in this case, security related to communication of the terminal is decreased.

In the case of periodic updating of the server certificate from the viewpoint of security, the versions of the server certificate retained by the terminal and the server certificate retained by the server apparatus may be different from each other, that is, the server certificates may be out of synchronization. In this case, even if a correct server apparatus issues the server certificate, the terminal may erroneously recognize the server apparatus to be incorrect by signature verification that uses the server certificate. That is, accuracy of signature verification is decreased.

Hereinafter, a signature verification device, a signature generation device, a signature processing system, a signature verification method, and a signature generation method that can reduce decrease of accuracy of signature verification with reduced cost and secured security will be described.

### Exemplary Embodiment

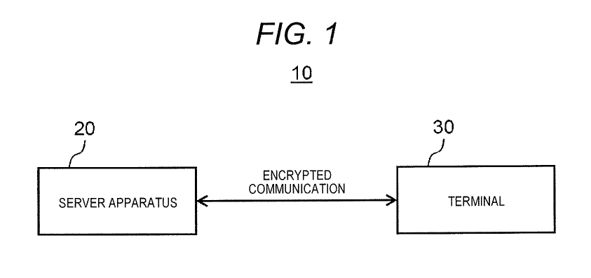

FIG. 1 is a block diagram illustrating a configuration example of signature processing system 10 in the exemplary embodiment. Signature processing system 10 has a configuration in which server apparatus 20 and terminal 30 are connected to a network or the like and are communicably connected to each other. Server apparatus 20 and terminal 30 perform encrypted communication by a public key encryption scheme. While the case of one terminal 30 being connected to server apparatus 20 is illustrated here, the same applies in the case of a plurality of terminals 30 being connected thereto.

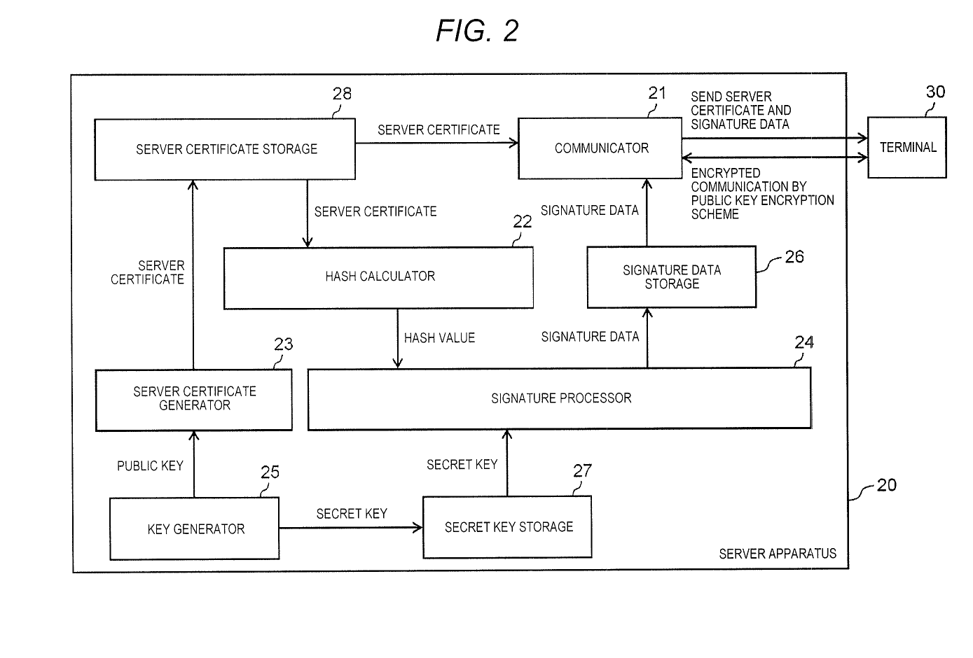

FIG. 2 is a block diagram illustrating a configuration example of server apparatus 20. Server apparatus 20 has communicator 21, hash calculator 22, server certificate generator 23, signature processor 24, key generator 25, signature data storage 26, secret key storage 27, and server certificate storage 28.

Server apparatus 20 has, for example, a central processing unit (CPU) or a digital signal processor (DSP). Server apparatus 20 has a read only memory (ROM) or a random access memory (RAM). For example, the CPU or the DSP executing a program retained in the ROM or the RAM realizes functions of each unit of hash calculator 22, server certificate generator 23, signature processor 24, and key generator 25.

Key generator 25, for example, periodically generates a key pair that is configured of a public key and a secret key used in a public key encryption scheme. Accordingly, security can be improved, compared with the case of not updating the key pair. The key pair may be generated outside of server apparatus 20 and registered in server apparatus 20.

Secret key storage 27 stores the secret key generated by key generator 25. In the case of updating the secret key, it is preferable that the secret key that is used until the end of a series of update works for the server certificate be discarded in terms of security.

Server certificate generator 23, for example, periodically generates the server certificate by using the public key generated by key generator 25. The server certificate includes, for example, the public key and additional information (company name and the like). Accordingly, security can be improved, compared with the case of not updating the server certificate. The server certificate may not include the additional information. That is, the server certificate may be the same as the public key. The server certificate may be generated outside of server apparatus 20 and registered in server apparatus 20 like the key pair.

Server certificate storage 28 stores the server certificate generated by server certificate generator 23. In the case of updating the server certificate, the server certificate that is used until the update may be discarded or remain retained in server certificate storage 28.

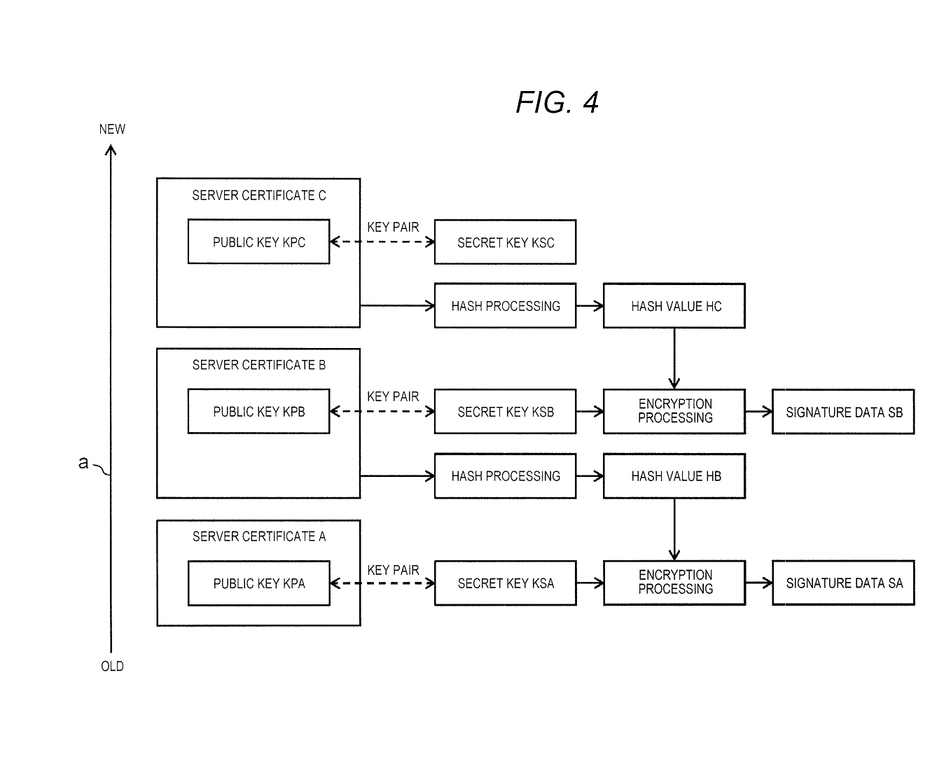

For example, the server certificate is generated in the order of server certificates A, B, and C in time series (refer to FIG. 4). That is, server certificate A is the oldest, and server certificate C is the latest. The public key, the secret key, the signature data, and a hash value are also designated by corresponding reference signs in time series like the server certificate.

Hash calculator 22 calculates the hash value of the server certificate stored in server certificate storage 28 by using a hash function that is one of unidirectional functions. For example, message digest algorithm 5 (MD5), secure hash algorithm (SHA) 1, SHA256, SHA512, and pseudo random function (PRF) functions are used as the unidirectional functions. The unidirectional function is not particularly limited if being the same function as terminal 30.

Signature processor 24 encrypts the hash value, calculated by hash calculator 22, with the secret key stored in secret key storage 27 to generate signature data. For example, signature processor 24 encrypts hash value HB of server certificate B with previous (previous generation) secret key KSA to generate signature data SA (refer to FIG. 4).

Signature data storage 26 is a writable storage medium and stores the signature data generated by signature processor 24.

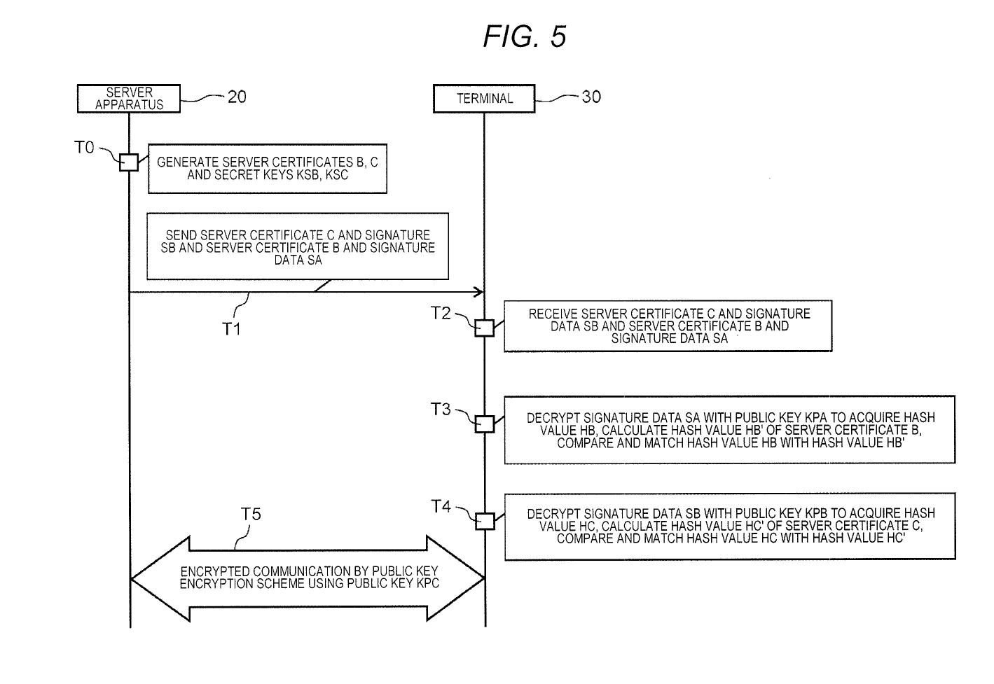

Communicator 21 communicates with various types of data. Communicator 21, for example, sends the server certificate stored in server certificate storage 28 and the signature data stored in signature data storage 26 to terminal 30. For example, server certificate B and signature data SA may be sent as one set (refer to FIG. 5) or may be separately sent. Signature data SA may be incorporated into server certificate B.

Communicator 21, for example, performs encrypted communication (for example, secure sockets layer (SSL) communication) with terminal 30 in accordance with a public key encryption scheme. Communicator 21, for example, communicates with terminal 30 through a network. The network includes, for example, the Internet, a wired local area network (LAN), and a wireless LAN. Communicator 21 may communicate with terminal 30 by using short-range wireless communication such as Bluetooth (registered trademark).

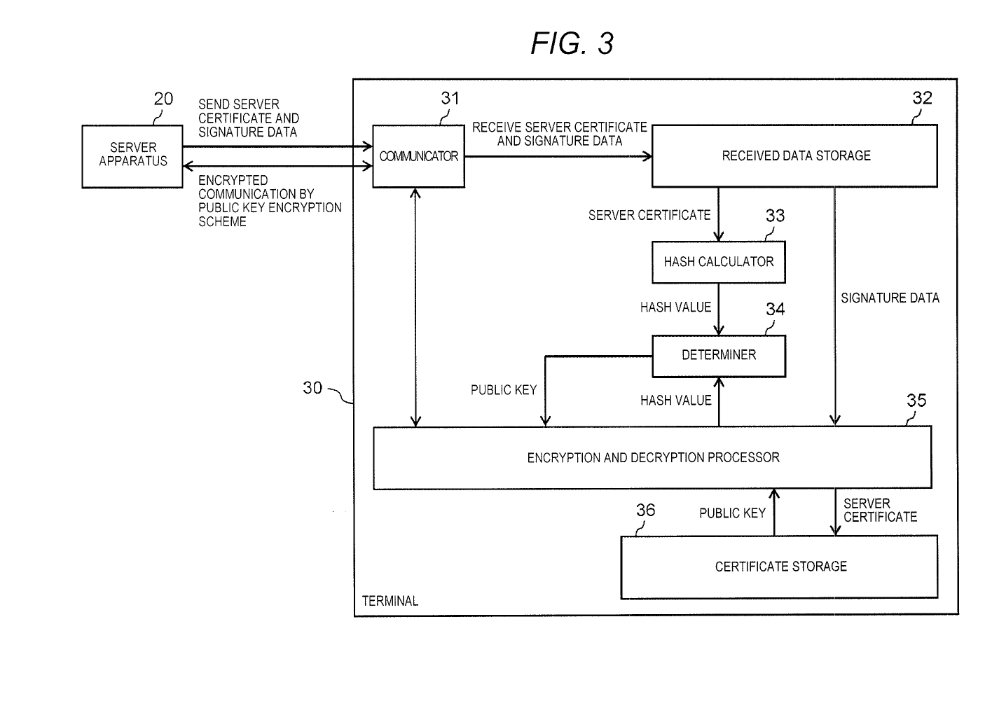

FIG. 3 is a block diagram illustrating a configuration example of terminal 30. Terminal 30 has communicator 31, received data storage 32, hash calculator 33, determiner 34, encryption and decryption processor 35, and certificate storage 36.

Terminal 30 has, for example, a CPU or a DSP and a ROM or a RAM. For example, the CPU or the DSP executing a program retained in the ROM or the RAM realizes function of each unit of hash calculator 33, determiner 34, and encryption and decryption processor 35.

Communicator 31 communicates with various types of data. Communicator 31, for example, receives the server certificate and the signature data sent from server apparatus 20. For example, server certificate B and signature data SA are received as one set (refer to FIG. 5).

Communicator 31, for example, performs encrypted communication (for example, SSL communication) with server apparatus 20 in accordance with a public key encryption scheme. Communicator 31, for example, communicates with server apparatus 20 through a network. The network includes, for example, the Internet, a wired LAN, and a wireless LAN. Communicator 31 may communicate with server apparatus 20 by using short-range wireless communication such as Bluetooth (registered trademark).

Received data storage 32 is a writable storage medium and stores the server certificate and the signature data received by communicator 31.

Hash calculator 33 calculates the hash value of the server certificate stored in received data storage 32 by using a hash function that is one of unidirectional functions. For example, MD5, SHA1, SHA256, SHA512, and PRF functions are used as the unidirectional functions. The unidirectional function is not particularly limited if being the same function as server apparatus 20.

Encryption and decryption processor 35 decrypts the signature data, stored in received data storage 32, with the public key included in the server certificate stored in certificate storage 36 to acquire the hash value of the server certificate. For example, encryption and decryption processor 35 decrypts signature data SA with public key KPA included in the previous generation (previous) server certificate A to acquire hash value HB of server certificate B (refer to FIG. 4).

Encryption and decryption processor 35, when performing encrypted communication with server apparatus 20 using the latest public key, decrypts data received from server apparatus 20 by using the latest public key. Encryption and decryption processor 35, when performing encrypted communication with server apparatus 20 using the latest public key, encrypts data sent to server apparatus 20 by using the latest public key.

Determiner 34 compares the hash value of the server certificate acquired by encryption and decryption processor 35 with the hash value calculated by hash calculator 33 to determine whether or not these hash values match. In the case of both hash values matching, terminal 30 can determine the signature data to be correct and thus can recognize that a post-update server certificate is acquired from correct server apparatus 20.

In consequence of determination by determiner 34, in the case of both hash values matching, encryption and decryption processor 35 stores, in certificate storage 36, the server certificate that includes the public key and is stored in received data storage 32. In the case of certificate storage 36 previously storing a server certificate, encryption and decryption processor 35 updates the server certificate with the server certificate that includes the public key and is stored in received data storage 32. Encryption and decryption processor 35 may store or update the public key in certificate storage 36 without storing the server certificate therein.

Certificate storage 36 is a writable storage medium. For example, when terminal 30 is manufactured, a server certificate that includes an initial public key (here, server certificate A) is stored in certificate storage 36.

In consequence of determination by determiner 34, in the case of the hash values not matching, encryption and decryption processor 35 may not particularly perform processing or may disconnect a communication session established with server apparatus 20.

Next, an operation example of signature processing system 10 will be described.

FIG. 4 is a schematic diagram for describing one example of updating of the server certificate and the signature data. As illustrated by arrow a in the drawing, more recent date and time are more upwards.

At the beginning of manufacturing of terminal 30, in server apparatus 20, key generator 25 generates a key pair that is configured of initial public key KPA and secret key KSA, and server certificate generator 23 creates server certificate A that includes public key KPA. Secret key KSA is stored in secret key storage 27. Server certificate A that includes initial public key KPA is sent from server apparatus 20 to terminal 30 and written into certificate storage 36 of terminal 30. A method for sending server certificate A from server apparatus 20 to terminal 30 is not limited to network transfer. For example, server certificate A may be sent through an external storage medium.

Then, in server apparatus 20, key generator 25 generates a key pair that is configured of new public key KPB and secret key KSB, and server certificate generator 23 creates server certificate B that includes public key KPB. New secret key KSB is stored in secret key storage 27. Hash calculator 22 calculates hash value HB of server certificate B. Signature processor 24 encrypts hash value HB with previous generation (previous) secret key KSA to generate signature data SA. Signature processor 24, after creating signature data SA, may discard secret key KSA that is used thus far.

Accordingly, the secret key that forms a key pair with the public key of the server certificate is different by one generation from the secret key used in generation of the signature data. For example, signature data SA and server certificate B as one set are sent from server apparatus 20 to terminal 30. While, for simplification of description, the secret key that forms a key pair with the public key of the server certificate is different by one generation from the secret key used in generation of the signature data, the secret keys can be different from each other by two or more generations.

Then, in server apparatus 20, key generator 25 generates a key pair that is configured of new public key KPC and secret key KSC, and server certificate generator 23 creates server certificate C that includes public key KPC. Secret key KSC is stored in secret key storage 27. Hash calculator 22 calculates hash value HC of server certificate C. Signature processor 24 encrypts hash value HC with secret key KSB to generate signature data SB. Signature processor 24, after creating signature data SB, may discard secret key KSB that is used thus far. For example, signature data SB and server certificate C as one set are sent from server apparatus 20 to terminal 30.

The hash value may be derived from the server certificate in which the additional information is added to the public key, or may be derived from the server certificate in which the additional information is not added to the public key.

FIG. 5 is a timing chart illustrating an update operation example for the server certificate. FIG. 5 illustrates that terminal 30 also performs updating corresponding to two generations after server apparatus 20 performs updating of the key pair and the server certificate corresponding to two generations.

In server apparatus 20, key generator 25 generates a key pair that is configured of secret key KSB and public key KPB, and server certificate generator 23 generates server certificate B that includes public key KPB. Key generator 25 updates public key KPA stored in secret key storage 27 with public key KPB, and server certificate generator 23 updates server certificate A stored in server certificate storage 28 with server certificate B (T0).

Hash calculator 22 calculates hash value HB of server certificate B. Signature processor 24 encrypts hash value HB with previous generation (previous) secret key KSA to generate signature data SA.

Similarly, key generator 25 generates a key pair that is configured of secret key KSC and public key KPC, and server certificate generator 23 generates server certificate C that includes public key KPC. Key generator 25 updates public key KPB stored in secret key storage 27 with public key KPC, and server certificate generator 23 updates server certificate B stored in server certificate storage 28 with server certificate C (T0).

Hash calculator 22 calculates hash value HC of server certificate C. Signature processor 24 encrypts hash value HC with previous generation (previous) secret key KSB to generate signature data SB.

Communicator 21 sends server certificate C and signature data SB (one set) and server certificate B and signature data SA (one set) to terminal 30 (T1).

While, for simplification of description, communicator 21 sends server certificate C and signature data SB (one set) and server certificate B and signature data SA (one set) once to terminal 30, communicator 21 may perform the sending in accordance with an instruction of terminal 30.

In actual use, for example, if terminal 30 requests the server certificate from server apparatus 20 in the case of terminal 30 not storing the server certificate received from server apparatus 20, transfer efficiency is improved. At this point, it is preferable that terminal 30 present the currently stored server certificate to server apparatus 20. It is preferable that server apparatus 20 recognize a difference in generation between the server certificate stored by terminal 30 and the latest server certificate stored by server apparatus 20 and send the server certificate corresponding to the difference and the signature data.

In terminal 30, communicator 31 receives and stores, in received data storage 32, server certificate C and signature data SB and server certificate B and signature data SA from server apparatus 20 (T2).

Encryption and decryption processor 35 decrypts signature data SA by using public key KPA included in server certificate A that is stored in certificate storage 36, for example, at the time of manufacturing, and acquires hash value HB of server certificate B. Hash calculator 33 calculates hash value HB′ of server certificate B stored in received data storage 32. Determiner 34 compares hash value HB with hash value HB′ (T3).

In consequence of the comparison, in the case of hash value HB and hash value HB′ matching, encryption and decryption processor 35 decrypts signature data SB by using public key KPB included in server certificate B stored in received data storage 32, and acquires hash value HC of server certificate C. Hash calculator 33 calculates hash value HC′ of server certificate C stored in received data storage 32. Determiner 34 compares hash value HC with hash value HC′ (T4).

In consequence of the comparison, in the case of hash value HC and hash value HC′ matching, determiner 34 determines server apparatus 20 to be a correct server apparatus. Server apparatus 20 and terminal 30 perform encrypted communication by a public key encryption scheme by using latest public key KPC (T5). It is preferable that terminal 30 store server certificate C or public key KPC and use server certificate C or public key KPC from subsequent communication.

Meanwhile, in the case of hash value HB and hash value HB′ not matching, or in the case of hash value HC and hash value HC′ not matching, determiner 34 determines server apparatus 20 to be an incorrect server apparatus. In this case, server apparatus 20 and terminal 30 do not perform encrypted communication in T5.

While illustrated here is the case of update processing of two sets of server certificate C and signature data SB and server certificate B and signature data SA in oldest order, the same applies in the case of update processing of three or more sets in oldest order.

The same applies in the case of updating the server certificate once. In this case, in server apparatus 20, communicator 21 sends server certificate B and signature data SA. In terminal 30, encryption and decryption processor 35 decrypts signature data SA with public key KPA that is written, for example, at the time of manufacturing, and acquires hash value HB of server certificate B. Hash calculator 33 calculates hash value HB′ of received server certificate B. In the case of hash value HB and hash value HB′ matching, determiner 34 determines public key KPB included in server certificate B to be the latest public key. Accordingly, both server apparatus 20 and terminal 30 can recognize that public key KPB is the latest public key.

According to the operation of signature processing system 10, in the case of periodic updating of the server certificate from the viewpoint of security, difference between the version of the latest server certificate retained by server apparatus 20 and the version of the latest server certificate retained by terminal 30 can be resolved. Therefore, signature processing system 10 can reduce decrease of accuracy of signature verification of the server certificate performed between terminal 30 and server apparatus 20 while securing security.

A certificate authority which is a third party is not necessarily required between server apparatus 20 and terminal 30. Thus, signature processing system 10 can reduce cost without incurring expense of digital signature by the certificate authority. Signature processing system 10 can reduce terminal 30 acquiring an incorrect public key and can reduce the possibility of spoofing that makes an incorrect server apparatus to be a connection target of terminal 30.

The public key that is included in the latest server certificate when server apparatus 20 is determined to be correct is used to perform encrypted communication. Thus, signature processing system 10 can secure security at the time of communication.

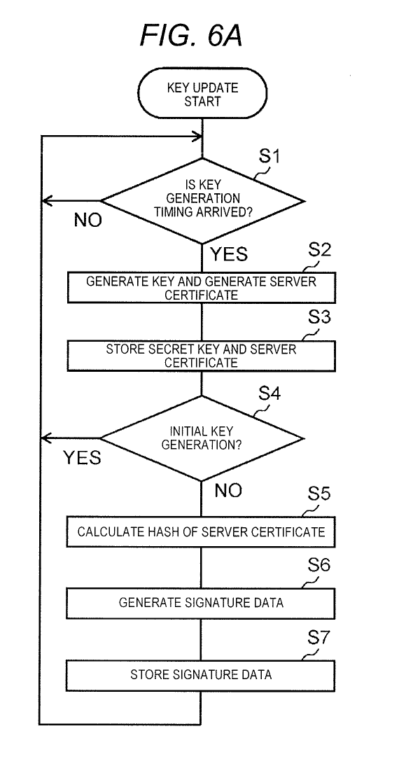

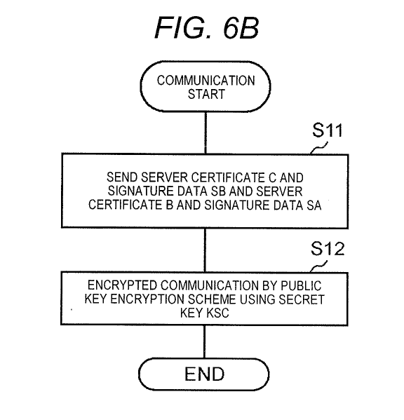

FIG. 6A and FIG. 6B are flowcharts illustrating an operation example of server apparatus 20. FIG. 6A is a flowchart illustrating one example of a generation operation procedure for the server certificate and the signature data by server apparatus 20.

First, key generator 25 waits until a timing of key generation arrives by an event (for example, a periodic event) such as elapsing of a predetermined amount of time (S1).

If the timing of key generation arrives, key generator 25 generates a key pair that is configured of a public key and a secret key (S2). Server certificate generator 23 generates a server certificate that includes the public key (S2).

Secret key storage 27 stores the secret key of the key pair generated by key generator 25 (S3). Server certificate storage 28 stores the generated server certificate (S3).

A controller (not illustrated) of server apparatus 20 determines whether or not the current key generation is initial (first) key generation. (S4). In the case of first key generation such as at the time of manufacturing terminal 30, server apparatus 20 returns to the process of S1. Meanwhile, in the case of the current key generation being second key generation or later, server apparatus 20 proceeds to a process of S5. The return to the process of S1 is to generate signature data by using data of a different generation.

Hash calculator 22 calculates the hash value of the server certificate generated in S2 (S5). Signature processor 24 encrypts the hash value, calculated in S5, by using the previous secret key that is generated in the previous generation (previous) key generation, and generates signature data (S6). Signature data storage 26 stores the signature data generated in S6 (S7). Then, server apparatus 20 returns to the process of S1.

FIG. 6B is a flowchart illustrating one example of a communication operation procedure by server apparatus 20. Communicator 21 sends, for example, above server certificate C and signature data SB and server certificate B and signature data SA to terminal 30 (S11).

In the case of signature data SB being verified by terminal 30 with a normal verification result (for example, hash values HB and HB′ match), communicator 21 performs encrypted communication with terminal 30 by a public key encryption scheme using secret key KSC stored in secret key storage 27 (S12). Then, server apparatus 20 finishes the present operation.

According to the operation of server apparatus 20, in the case of periodic updating of the server certificate from the viewpoint of security, difference between the version of the latest server certificate retained by server apparatus 20 and the version of the latest server certificate retained by terminal 30 can be resolved. Therefore, server apparatus 20 can reduce decrease of accuracy of signature verification of the server certificate performed between terminal 30 and server apparatus 20 while securing security.

A certificate authority which is a third party is not necessarily required between server apparatus 20 and terminal 30. Thus, server apparatus 20 can reduce cost without incurring expense of digital signature by the certificate authority. Server apparatus 20 can reduce terminal 30 acquiring an incorrect public key and can reduce the possibility of spoofing that makes an incorrect server apparatus to be a connection target of terminal 30.

Since server apparatus 20 can perform encrypted communication with terminal 30 by using the public key included in the latest server certificate, security at the time of communication can be secured.

Server apparatus 20, in the case of updating the key, may not initially send server certificate C and signature data SB and server certificate B and signature data SA to terminal 30 and may first perform encrypted communication with terminal 30 by a typical public key encryption scheme.

In this case, server apparatus 20 sends server certificate C, which is the latest certificate, to terminal 30 and tries to perform encrypted communication by a public key encryption scheme. In the case of a response that terminal 30 cannot recognize server certificate C, in other words, in the case of terminal 30 sending a request signal for requesting the latest server certificate, server apparatus 20 may send server certificate C and signature data SB and server certificate B and signature data SA. That is, server apparatus 20 may perform processing related to key updating in the case of receiving a request signal from terminal 30. Accordingly, load on communication processing can be reduced in the case of server certificate B, signature data SB, and signature data SA not being required, and traffic on the network can be reduced.

Server apparatus 20 may perform processing related to key updating not only in the case of receiving a request signal from terminal 30 but also in the case of a communication request being made in server apparatus 20.

Terminal 30, in the case of responding that server certificate C cannot be recognized, may notify the server certificate retained by terminal 30 (for example, server certificates B and A) to server apparatus 20. Accordingly, server apparatus 20 can be prevented from performing an unnecessary operation such as sending server certificate B to the terminal even though terminal 30 previously retains server certificate B.

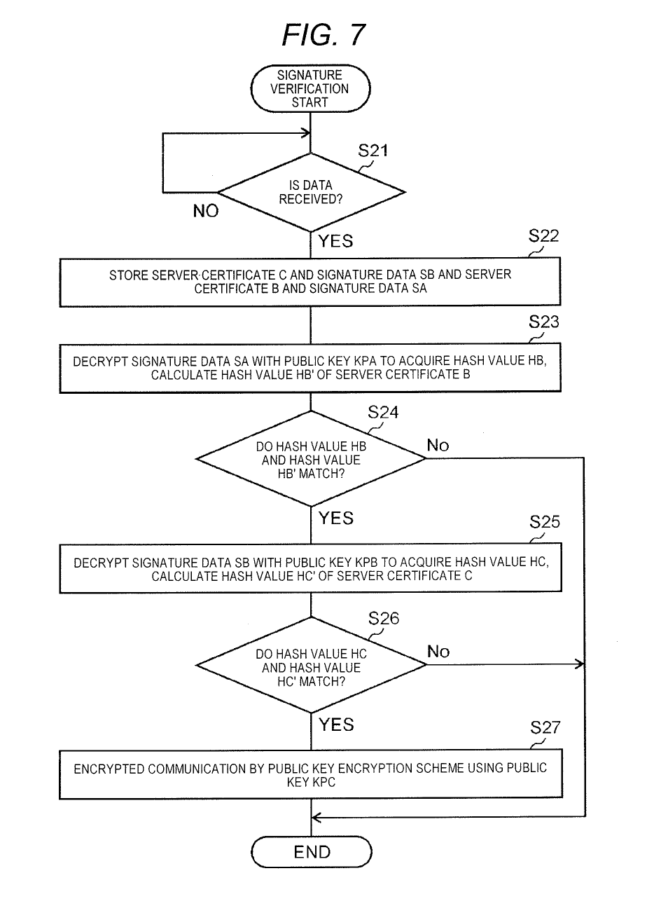

FIG. 7 is a flowchart illustrating one example of a signature verification operation procedure by terminal 30. The same case as in FIG. 5 is assumed in FIG. 7. That is, as an initial state, server apparatus 20 retains server certificates C and B and signature data SB and signature data SA, and terminal 30 retains server certificate A that includes public key KPA.

First, communicator 31 waits until receiving data from server apparatus 20 (S21). Communicator 31, if receiving data, stores server certificate C and signature data SB and server certificate B and signature data SA, which are the received data, in received data storage 32 (S22).

Encryption and decryption processor 35 decrypts signature data SA with public key KPA stored in certificate storage 36 to acquire hash value HB. Hash calculator 33 calculates hash value HB′ of server certificate B (S23).

Determiner 34 compares hash value HB with hash value HB′ and determines whether or not these hash values match (S24). In the case of the hash values matching, encryption and decryption processor 35 decrypts signature data SB with public key KPB included in server certificate B to acquire hash value HC. Hash calculator 33 calculates hash value HC′ of server certificate C (S25).

Determiner 34 compares hash value HC with hash value HC′ and determines whether or not these hash values match (S26). In the case of the hash values matching, communicator 31 performs encrypted communication with terminal 30 by a public key encryption scheme using latest public key KPC (S27). Then, terminal 30 finishes the present operation.

Meanwhile, in the case of determiner 34 determining non-matching in S24 or S26, terminal 30 finishes the present operation without performing encrypted communication.

According to the operation of terminal 30, in the case of periodic updating of the server certificate from the viewpoint of security, difference between the version of the latest server certificate retained by server apparatus 20 and the version of the latest server certificate retained by terminal 30 can be resolved. Therefore, terminal 30 can reduce decrease of accuracy of signature verification of the server certificate performed between the terminal and the server apparatus while securing security.

A certificate authority which is a third party is not necessarily required between server apparatus 20 and terminal 30. Thus, cost is reduced without incurring expense of digital signature by the certificate authority. Terminal 30 can reduce acquisition of an incorrect public key and can reduce the possibility of spoofing that makes an incorrect server apparatus to be a connection target of terminal 30.

Since terminal 30 can perform encrypted communication with server apparatus 20 by using the public key included in the latest server certificate, security at the time of communication can be secured.

In the case of terminal 30 being an embedded device and having remote maintenance function, terminal 30 can verify whether or not a communication target (a server apparatus, a reader, or the like) providing a remote maintenance instruction is a correct communication target. Therefore, terminal 30 can improve security related to remote maintenance.

While an exemplary embodiment is described heretofore with reference to the drawings, the present disclosure is obviously not limited to such an example. Various modification examples or correction examples may apparently be perceived by those skilled in the art within the scope disclosed in the claims, and those examples are obviously understood to fall within the technical scope of the present disclosure.

While the above exemplary embodiment mainly illustrates encrypting the hash value of the server certificate to generate the signature data, the signature data may be generated by encrypting the hash value of any data including the public key included in the server certificate and partial data of the public key. Accordingly, encryption processing of the additional information is omitted at the time of generating the signature data, and thus, load on encryption processing can be reduced. The amount of data at the time of communication is also decreased, and thus, traffic on the network can be reduced.

The above exemplary embodiment mainly illustrates server apparatus 20 as sending the server certificate generated in the past (except for the server certificate at the time of manufacturing) and the signature data to the terminal in the case of terminal 30 not being able to recognize data encrypted with the latest secret key. Instead, server apparatus 20 may receive information as to the version of the latest server certificate retained by terminal 30 and send a later version of the server certificate and the signature data. Accordingly, the amount of data at the time of communication is decreased, and thus, processing load can be reduced, and traffic on the network can be reduced.

As described heretofore, terminal 30 includes certificate storage 36, communicator 31, encryption and decryption processor 35, hash calculator 33, and determiner 34. Certificate storage 36 stores server certificate A that includes public key KPA. Communicator 31 receives server certificate B that includes public key KPB, and signature data SA that is generated by encrypting hash value HB which is derived from server certificate B by using secret key KSA forming a key pair with public key KPA. Encryption and decryption processor 35 decrypts signature data HA by using public key KPA to acquire hash value HB′. Hash calculator 33 derives hash value HB from server certificate B. Determiner 34, in the case of hash value HB′ and hash value HB matching, determines server apparatus 20 generating signature data SA to be correct.

Terminal 30 is one example of the signature verification device. Server apparatus 20 is one example of the signature generation device. Certificate storage 36 is one example of a storage. Encryption and decryption processor 35 is one example of a signature processor. Hash calculator 33 is one example of a unidirectional function deriver. Determiner 34 is one example of a signature verifier. Public key KPA is one example of a first public key. Public key KPB is one example of a second public key. Server certificate A is one example of a first server certificate. Server certificate B is one example of a second server certificate. Hash value HB′ is one example of a first hash value. Hash value HB is one example of a second hash value.

Accordingly, signature verification can be easily performed by using a hash value, and server spoofing can be reduced. Thus, security related to communication between terminal 30 and server apparatus 20 can be secured. If the versions of the server certificates retained by terminal 30 and server apparatus 20 are different from each other, correctness of server apparatus 20 can be appropriately verified by using the signature data that is generated based on the public key or the server certificate of a different generation. Therefore, accuracy of signature verification can be improved.

Communicator 31, in the case of determiner 34 determining server apparatus 20 to be correct, may perform encrypted communication with server apparatus 20 by using public key KPB.

Accordingly, in the case of the versions of the server certificates retained by terminal 30 and server apparatus 20 being different from each other, terminal 30 can safely acquire the post-update server certificate and use in encrypted communication.

Certificate storage 36 may store server certificate B in the case of determiner 34 determining server apparatus 20 to be correct.

Accordingly, terminal 30, after updating the server certificate, can safely perform encrypted communication with server apparatus 20 by using the server certificate until server apparatus 20 further updates the server certificate.

Server apparatus 20 includes key generator 25, server certificate generator 23, hash calculator 22, and signature processor 24. Key generator 25 generates a key pair of public key KPA and secret key KSA and a key pair of public key KPB and secret key KSB. Server certificate generator 23 generates server certificate A including public key KPA and updates server certificate A to generate server certificate B including public key KPB. Hash calculator 22 derives hash value HB from server certificate B. Signature processor 24 encrypts hash value HB by using secret key KSA to generate signature data SA.

Server certificate generator 23 is one example of a certificate generator. Hash calculator 22 is one example of a unidirectional function deriver. Signature processor 24 is one example of a signature generator. Secret key KSA is one example of a first secret key. Secret key KSB is one example of a second secret key.

Accordingly, signature data of a certificate authority is not required to be used, and thus, cost for digital signature can be reduced. Signature generation can be easily performed by using a hash value, and server spoofing can be reduced. Thus, security related to communication between terminal 30 and server apparatus 20 can be secured. Since server apparatus 20 generates the signature data by using information that is based on the public key or the server certificate of a different generation, correctness of server apparatus 20 can be appropriately verified by using the signature data even if the versions of the server certificates retained by terminal 30 and server apparatus 20 are different from each other. Therefore, accuracy of signature verification can be improved.

Communicator 21 may send server certificate B and signature data SA.

Accordingly, terminal 30 can acquire server certificate B and signature data SA and perform processing related to signature verification.

Communicator 21 may receive a request signal from terminal 30 that verifies signature data SA, and send server certificate B and signature data SA to terminal 30 in response to the request signal.

Accordingly, terminal 30, for example, in the case of the versions of the server certificates retained by server apparatus 20 and terminal 30 being different from each other, can acquire server certificate B and signature data SA and perform processing related to signature verification by requesting update information. Therefore, load on server apparatus 20 and terminal 30 can be reduced, and network traffic can be reduced.

Signature processing system 10 is a system in which server apparatus 20 and terminal 30 are connected to each other through a network.

Accordingly, signature data of a certificate authority is not required to be used, and thus, cost for digital signature can be reduced. Signature generation and signature verification can be easily performed by using a hash value, and server spoofing can be reduced. Thus, security related to communication between terminal 30 and server apparatus 20 can be secured. Since server apparatus 20 and terminal 30 perform signature generation and signature verification by using information that is based on the public key or the server certificate of a different generation, correctness of server apparatus 20 can be appropriately verified even if the versions of the server certificates retained by terminal 30 and server apparatus 20 are different from each other. Therefore, accuracy of signature verification can be improved.

The signature verification method in terminal 30 includes first to fourth steps below. The first step is receiving server certificate B that includes public key KPB, and signature data SA that is generated by encrypting hash value HB which is derived from server certificate B by using secret key KSA forming a key pair with public key KPA. The second step is decrypting signature data SA by using public key KPA to acquire hash value HB′. The third step is deriving hash value HB from server certificate B. The fourth step is determining server apparatus 20 generating signature data SA to be correct in the case of hash value HB′ and hash value HB matching.

Accordingly, signature verification can be easily performed by using a hash value, and server spoofing can be reduced. Thus, security related to communication between terminal 30 and server apparatus 20 can be secured. If the versions of the server certificates retained by terminal 30 and server apparatus 20 are different from each other, correctness of server apparatus 20 can be appropriately verified by using the signature data that is generated based on the public key or the server certificate of a different generation. Therefore, accuracy of signature verification can be improved.

The signature generation method in server apparatus 20 includes first to sixth steps below. The first step is generating a key pair of public key KPA and secret key KSA. The second step is a step of generating server certificate A that includes public key KPA. The third step is generating a key pair of public key KPB and secret key KSB. The fourth step is updating server certificate A to generate server certificate B that includes public key KPB. The fifth step is deriving hash value HB from server certificate B. The sixth step is encrypting hash value HB by using secret key KSA to generate signature data SA.

Accordingly, signature data of a certificate authority is not required to be used, and thus, cost for digital signature can be reduced. Signature generation can be easily performed by using a hash value, and server spoofing can be reduced. Thus, security related to communication between terminal 30 and server apparatus 20 can be secured. Since server apparatus 20 generates the signature data by using information that is based on the public key or the server certificate of a different generation, correctness of server apparatus 20 can be appropriately verified by using the signature data even if the versions of the server certificates retained by terminal 30 and server apparatus 20 are different from each other. Therefore, accuracy of signature verification can be improved.

### INDUSTRIAL APPLICABILITY

The present disclosure is useful for a signature verification device, a signature generation device, a signature processing system, a signature verification method, a signature generation method, and the like that can reduce decrease of accuracy of signature verification with reduced cost and secured security.

### REFERENCE MARKS IN THE DRAWINGS

10 signature processing system
20 server apparatus
21 communicator
22 hash calculator
23 server certificate generator
24 signature processor
25 key generator
26 signature data storage
27 secret key storage
28 server certificate storage
30 terminal
31 communicator
32 received data storage
34 determiner
33 hash calculator
35 encryption and decryption processor
36 certificate storage

1. A signature verification device comprising:
a storage that stores a first server certificate including a first public key;
a communicator that receives a second server certificate including a second public key and receives signature data which is generated by encrypting a hash value derived from the second server certificate using a secret key forming a key pair with the first public key;
a signature processor that decrypts the signature data by using the first public key to acquire a first hash value;
a unidirectional function deriver that derives a second hash value from the second server certificate; and
a signature verifier that determines a signature generation device generating the signature data to be correct in a case of the first hash value and the second hash value matching.

2. The signature verification device of claim 1,
wherein the communicator, in a case of the signature verifier determining the signature generation device to be correct, performs encrypted communication with the signature generation device by using the second public key.

3. The signature verification device of claim 1,
wherein the storage, in the case of the signature verifier determining the signature generation device to be correct, stores the second server certificate.

4. A signature generation device comprising:
a key generator that generates a key pair of a first public key and a first secret key and a key pair of a second public key and a second secret key;
a certificate generator that generates a first server certificate including the first public key and updates the first server certificate to generate a second server certificate including the second public key;
a unidirectional function deriver that derives a hash value from the second server certificate; and
a signature generator that encrypts the hash value by using the first secret key to generate signature data.

5. The signature generation device of claim 4, further comprising:
a communicator that sends the second server certificate and the signature data.

6. The signature generation device of claim 5,
wherein the communicator receives a request signal from a signature verification device verifying the signature data and sends the second server certificate and the signature data to the signature verification device in response to the request signal.

7. A signature processing system in which a signature generation device and a signature verification device are connected to each other through a network,
wherein the signature generation device includes
a key generator that generates a key pair of a first public key and a first secret key and a key pair of a second public key and a second secret key,
a certificate generator that generates a first server certificate including the first public key and updates the first server certificate to generate a second server certificate including the second public key,
a unidirectional function deriver that derives a hash value from the second server certificate,
a signature generator that encrypts the hash value by using the first secret key to generate signature data, and
a first communicator that sends the second server certificate and the signature data, and
the signature verification device includes
a storage that stores the first server certificate including the first public key,
a second communicator that receives the second server certificate and the signature data,
a signature processor that decrypts the signature data by using the first public key to acquire a first hash value,
a unidirectional function deriver that derives a second hash value from the second server certificate, and
a signature verifier that determines the signature generation device to be correct in a case of the first hash value and the second hash value matching.

8. A signature verification method in a signature verification device including a storage that stores a first server certificate including a first public key, the method comprising:
a step of receiving a second server certificate including a second public key and receiving signature data which is generated by encrypting a hash value derived from the second server certificate using a secret key forming a key pair with the first public key;
a step of decrypting the signature data by using the first public key to acquire a first hash value;
a step of deriving a second hash value from the second server certificate; and
a step of determining a signature generation device generating the signature data to be correct in a case of the first hash value and the second hash value matching.

9. A signature generation method in a signature generation device, the method comprising:
a step of generating a key pair of a first public key and a first secret key;
a step of generating a first server certificate including the first public key;
a step of generating a key pair of a second public key and a second secret key;
a step of updating the first server certificate to generate a second server certificate including the second public key;
a step of deriving a hash value from the second server certificate; and
a step of encrypting the hash value by using the first secret key to generate signature data.
